(19) United States
(12) Patent Application Publication
(10) Pub. No.: US 2016/0029079 A1
(43) Pub. Date: Jan. 28, 2016

(54) Method and Device for Playing and Processing a Video Based on a Virtual Desktop

(71) Applicant: ZTE CORPORATION, Shenzhen (CN)

(72) Inventors: Shijun ZHOU, Shenzhen (CN); Yongyin WANG, Shenzhen (CN); Xiang HUANG, Shenzhen (CN); Yuwen YE, Shenzhen (CN)

(21) Appl. No.: 14/774,897

(22) PCT Filed: Aug. 21, 2013
(86) PCT No.: PCT/CN2013/082012

§ 371 Date: Sep. 11, 2015

(30) Foreign Application Priority Data
Mar. 12, 2013 (CN) 201310078253.6

(51) Int. Cl. H04N 21/443; H04N 21/2385; H04N 21/854

(52) U.S. Cl. CPC H04N 21/4437; H04N 21/85403; H04N 21/2385

(57) ABSTRACT

Provided a method and device for playing and processing a video based on a virtual desktop. The method comprises: a terminal receives a original code stream of a video file to be played currently, wherein the original code stream is sent to the terminal by a virtual desktop system after the virtual desktop acquires the original code stream; and the terminal plays the video file according to the original code stream. The disclosure avoids or reduces the occupation of Central Processing Unit (CPU) resources of a virtual machine host, and achieves smooth playback of video files.

### TECHNICAL FIELD

The disclosure relates to the field of communications, and including a method and device for playing and processing a video based on a virtual desktop.

### BACKGROUND

With the evolution of IT technology, infrastructures also are advancing; with the gradual maturity of virtual technology, the development of the cloud computation has reached a new stage. The cloud computation is the development and commercial realization of distributed process, parallel computation, grid computation and other concepts; the technical essence of the cloud computation is the virtualization of IT software and hardware resources, such as computation, storage, server, application software; the cloud computation has its unique technology in the aspects of virtualization, data storage, data management, programming mode and so on.

Virtual machine (that is, server virtualization) is the important foundation of the underlying infrastructure of the cloud computation. In the virtualization of the server, the virtualization software needs to realize the functions, such as, the abstraction of hardware, the allocation, scheduling and management of resources, the isolation between a virtual machine and a host operating system, and the isolations among multiple virtual machines; at present, the typical virtual machine (which almost becomes an actual standard) includes Citrix Xen, VMare ESX Server, Microsoft Hype-V and so on.

The virtual desktop of the cloud computation creates a new Web application development and distribution platform based on cloud computation while highlighting and taking the advantages of desktop. Virtual desktop is a Web desktop, which runs on a browser and can integrate Web applications, Web services, C\S applications, C\S application servers and local client applications to one desktop environment.

At present, during the application of the virtual desktop, when a high-definition video is played on a virtual desktop server, images often are displayed slowly, unclearly, even can not be played; at present, there is no problem existing in the performances of the terminal, and the problem lies in two aspects as follows: 1. the performance of the host of the virtual machine, specifically, the compression of image data consumes lots of resources of the Central Processing Unit (CPU), especially high-definition videos; 2. the network bandwidth between a terminal and a virtual server is insufficient.

FIG. 1 shows an implementation process of an image capture compression playing method according to related art; as shown in FIG. 1, the implementation process mainly includes following steps:

(1) On a virtual desktop, a media-player program is started, and a media file is opened by a media-player.

(2) A virtual desktop operating system scans out a changed area from the desktop and obtains relative graphic information (mainly referring to the information in the Graphic Processing Unit (GPU)).

(3) The virtual desktop system compresses the graphic information, wherein the compression mainly adopts the Motion Joint Photographic Experts Group (MJPEG) format at present.

(4) The compressed graphic information is transmitted to a terminal through a network.

(5) The terminal decompresses the image after receiving the compressed graphic information.

(6) The terminal system recycles the image.

In the above implementation process, since images are compressed in Step (3), the occupation of CPU resources is significant; in this condition, the performance of the host of the virtual machine is greatly reduced, thus the playing of high-definition videos on the virtual desktop server is prone to failure.

In view of the problem that the playing of high-definition videos on the virtual desktop server is prone to failure because of the poor performance of the virtual server or that the bandwidth between the terminal and the virtual server is insufficient in related art, no solution has been proposed so far.

### SUMMARY

A method and device for playing and processing a video based on a virtual desktop are provided, to at least solve the above problems.

According to a first aspect of the embodiment, a method for playing a video based on a virtual desktop is provided, comprising: receiving, by a terminal, an original code stream of a video file to be played currently, wherein the original code stream is sent to the terminal by a virtual desktop system after the virtual desktop acquires the original code stream; and playing, by the terminal, the video file according to the original code stream.

According to a second aspect of the embodiment, a device for playing a video based on a virtual desktop is provided, comprising: a receiving component, configured to receive an original code stream of a video file to be played currently, wherein the original code stream is sent to a terminal by a virtual desktop system after the virtual desktop acquires the original code stream; and a playing component, configured to play the video file according to the original code stream.

According to a third aspect of the embodiment, a method for processing a video based on a virtual desktop is provided, comprising: sending, by a virtual desktop system, an original code stream of a video file to be played currently to a video format converter for format conversion; sending, by the virtual desktop system, the converted code stream to a terminal to for video playing.

In an example embodiment, before the virtual desktop system sends the original code stream of the video file to be played currently to the video format converter for format conversion, the method further comprises: acquiring, by the virtual desktop system, the original code stream from the video file.

In an example embodiment, the video format converter is set on a virtual server in advance.

According to fourth aspect of the embodiment, a device for processing a video based on a virtual desktop is provided, comprising: a first sending component, configured to send an original code stream of a video file to be played currently to a video format converter for format conversion, wherein the video format converter is set on a virtual server in advance; and a second sending component, configured to send the converted code stream to a terminal to for video playing.

According to fifth aspect of the embodiment, a method for processing a video based on a virtual desktop is provided, comprising: scanning, by a virtual desktop system, a video file on the virtual desktop to obtain first graphic information for describing a change area of the video file; sending, by the virtual desktop system, the first graphic information to a format compressor for compression; and sending, by the virtual desktop system, second graphic information obtained by compression to a terminal to for video playing.

In an example embodiment, the first graphic information comprises: information located in a Graphics Processing Unit (GPU).

According to sixth aspect of the embodiment, a device for processing a video based on a virtual desktop is provided, comprising: a scanning component, configured to scan a video file on the virtual desktop to obtain first graphic information for describing a change area of the video file; a first sending component, configured to send the first graphic information to a format compressor for compression; and a second sending component, configured to send second graphic information obtained by compression to a terminal to for video playing.

In an example embodiment, the first graphic information comprises: information located in a Graphics Processing Unit (GPU).

According to seventh aspect of the embodiment, a method for processing a video based on a virtual desktop is provided, comprising: scanning, by a virtual desktop system, a video file on the virtual desktop to obtain first graphic information for describing a change area of the video file; sending, by the virtual desktop system, the first graphic information and a preset compression policy to a virtual server or a preset compressor for compression, wherein the preset compression policy is used for dynamically adjusting to different compression ratios based on different network bandwidths; and sending, by the virtual desktop system, second graphic information obtained by compression to a terminal for video playing.

In an example embodiment, the preset compression policy comprises multiple different compression ratios, wherein a compression ratio is in proportion to a network bandwidth.

In an example embodiment, the first graphic information comprises: information located in a Graphics Processing Unit (GPU).

According to a eighth aspect of the embodiment, a device for processing a video based on a virtual desktop is provided, comprising: a scanning component, configured to scan a video file on the virtual desktop to obtain first graphic information for describing a change area of the video file; a first sending component, configured to send the first graphic information and a preset compression policy to a virtual server or a preset compressor for compression, wherein the preset compression policy is used for dynamically adjusting to different compression ratios based on different network bandwidths; and a second sending component, configured to send second graphic information obtained by compression to a terminal to for video playing.

The disclosure solves the problem that the playing of high-definition videos on a virtual desktop server is prone to failure because of the poor performance of the virtual server or that the bandwidth between the terminal and the virtual server is insufficient in related art, avoids or reduces the occupation of CPU resources of the host of the virtual machine and achieves smooth playing of the video files, by any one of the following methods that: the original code stream of the video file is directly sent to the terminal to play, a video converter preset on the virtual server converts the video file and then sends the converted video file to the terminal to decode and play, a video format compressor compresses the graphic information of the changed area of the video file and then sends the compressed file to the terminal to decompress and play, or the virtual desktop system compresses the graphic information of the changed area of the video file by using the compression ratio dynamically selected according to the current network bandwidth and then sends the compressed file to the terminal to decompress and play.

### BRIEF DESCRIPTION OF THE DRAWINGS

For a better understanding of the disclosure, accompanying drawings described hereinafter are provided to constitute one part of the application; the schematic embodiments of the disclosure and the description thereof are used to illustrate the disclosure but to limit the disclosure improperly. In the accompanying drawings:

FIG. 1 shows an implementation process of an image capture compression playing method according to related technology;

FIG. 2 shows a flowchart of a method for playing videos based on a virtual desktop according to Embodiment 1 of the disclosure;

FIG. 3 shows a structure diagram of an apparatus for playing videos based on a virtual desktop according to Embodiment 1 of the disclosure;

FIG. 4 shows a flow diagram of transmitting an original code stream to a terminal to play according to an example Embodiment 1 of the disclosure;

FIG. 5 shows a flowchart of a method for processing videos based on a virtual desktop according to Embodiment 2 of the disclosure;

FIG. 6 shows a structure diagram of an apparatus for processing videos based on a virtual desktop according to Embodiment 2 of the disclosure;

FIG. 7 shows a flow diagram of processing a converted original code stream in a terminal according to an example Embodiment 2 of the disclosure;

FIG. 8 shows a flowchart of a method for processing videos based on a virtual desktop according to Embodiment 3 of the disclosure;

FIG. 9 shows a structure diagram of an apparatus for processing videos based on a virtual desktop according to Embodiment 3 of the disclosure;

FIG. 10 shows a flow diagram of the implementation of an image compression sharing method according to an example Embodiment 3 of the disclosure;

FIG. 11 shows a flowchart of a method for processing videos based on a virtual desktop according to Embodiment 4 of the disclosure;

FIG. 12 shows a structure diagram of an apparatus for processing videos based on a virtual desktop according to Embodiment 4 of the disclosure; and

FIG. 13 shows a flow diagram of the implementation of a method for dynamically adjusting a compression ratio based on a network bandwidth according to an example embodiment 4 of the disclosure.

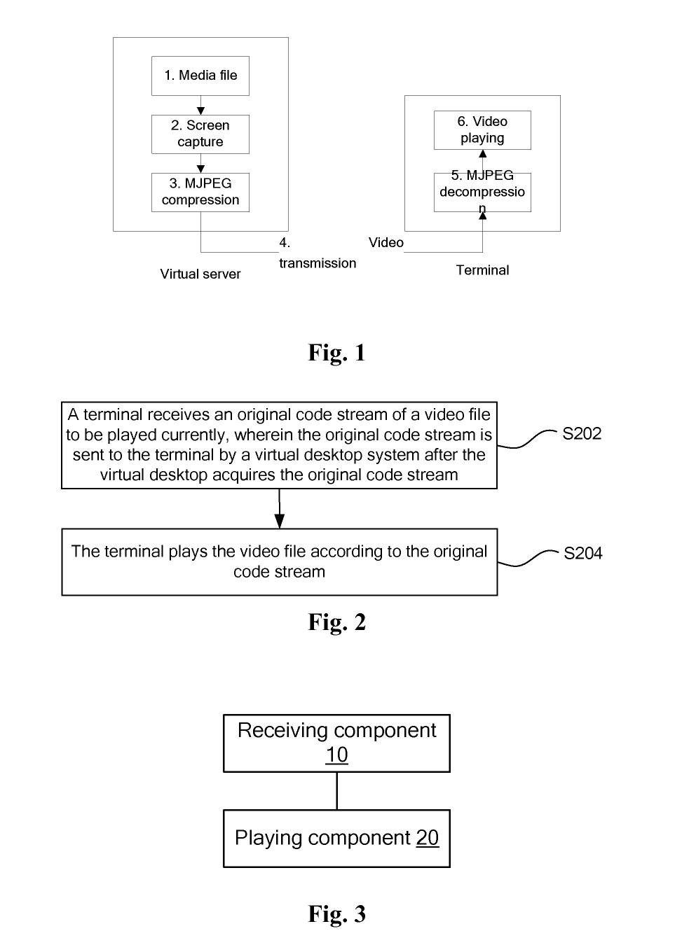

### DETAILED DESCRIPTION OF THE EMBODIMENTS

The disclosure is described below in detail by reference to the accompanying drawings in conjunction with embodiments. It should be noted that the embodiments in the application and the characteristics of the embodiments can be combined if no conflict is caused.

FIG. 2 shows a flowchart of a method for playing a video based on a virtual desktop according to Embodiment 1 of the disclosure; as shown in FIG. 2, the method mainly includes following steps (S202 to S204):

S202: A terminal receives an original code stream of a video file to be played currently, wherein the original code stream is sent to the terminal by a virtual desktop system after the virtual desktop acquires the original code stream.

S204: The terminal plays the video file according to the original code stream.

FIG. 3 shows a structure diagram of a device for playing a video based on a virtual desktop according to Embodiment 1 of the disclosure; the device is located at a terminal to implement the method for playing the video based on the virtual desktop shown in FIG. 2; as shown in FIG. 3, the device for playing the video based on the virtual desktop includes: a receiving component 10, which is configured to receive the original code stream of a video file to be played currently, wherein the original code stream is sent to the terminal after being acquired by the virtual desktop system; and a playing component 20, which is connected to the receiving component 10 and is configured to play the video file according to the original code stream.

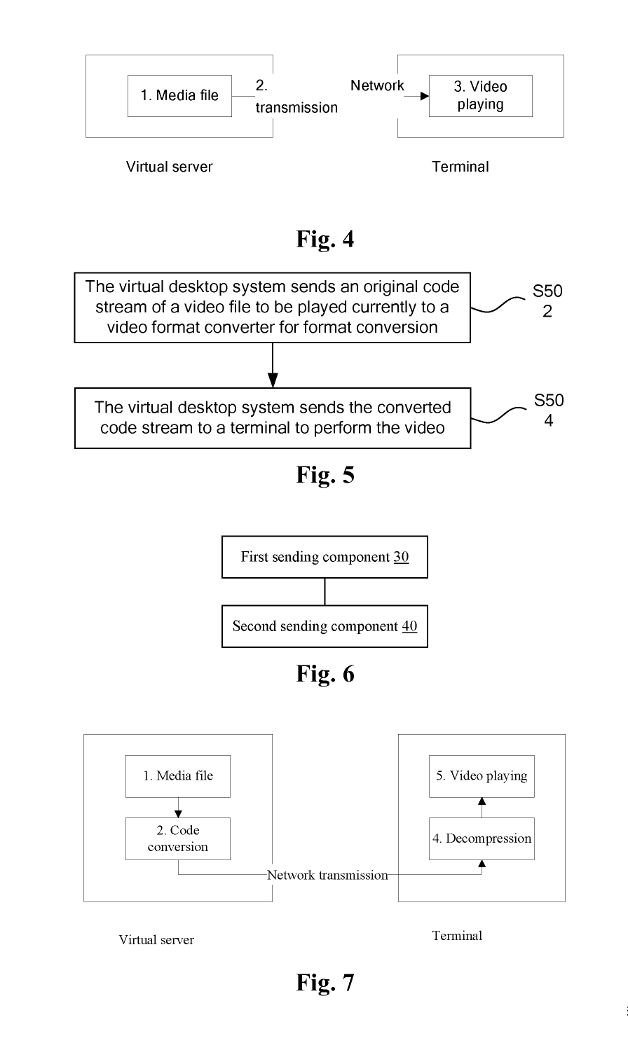

The method for playing the video based on the virtual desktop provided in Embodiment 1 of the disclosure is described below in further detail in conjunction with FIG. 4.

FIG. 4 shows a flow diagram of transmitting an original code stream to a terminal to play according to an example Embodiment 1 of the disclosure; in FIG. 4, after acquiring the original code stream of the video file to be played right now, the virtual desktop system does not process the original code stream but directly sends the original code stream to the terminal through a network, so that the terminal plays the video. Here, it is needed to note that the virtual desktop does not play the video file directly, which is different from playing the video on a Personal Computer (PC). After receiving the original code stream, the terminal can play the video file (which consists of the original code stream) without decoding the original code stream.

Here it is also needed to note that: (1) the original code stream forming the video file might not refer to the whole video file; the video file also can be played in a manner of streaming media and the video file is transmitted to the terminal in a manner similar to streaming media. The core of this playing method lies in that: the original code stream of the video file is not compressed and is directly sent to a client (terminal) to be played; (2) the media software can be designed to be similarly embedded into the desktop to play a video file.

Since the video file is not played at the server side, the CPU resources of the server is not occupied and the success ratio of playback is greatly improved.

FIG. 5 shows a flowchart of a method for processing a video based on a virtual desktop according to Embodiment 2 of the disclosure; as shown in FIG. 5, the method mainly includes following steps (S502 to S504):

S502: The virtual desktop system sends an original code stream of a video file to be played currently to a video format converter for format conversion.

S504: The virtual desktop system sends the converted code stream to a terminal to perform the video.

In this embodiment, before the virtual desktop system sends the original code stream of the video file to be played currently to the video format converter to perform the format conversion, the method further includes: the virtual desktop system acquires the original code stream from the video file.

In this embodiment, the video format converter is set on a virtual server in advance.

FIG. 6 shows a structure diagram of a device for processing a video based on a virtual desktop according to Embodiment 2 of the disclosure; the device is configured to implement the method for processing the video based on the virtual desktop shown in FIG. 5; as shown in FIG. 6, the device for processing the video based on the virtual desktop includes: a first sending component 30, which is configured to send the original code stream of a video file to be played currently to a video format converter for format conversion, wherein the video format converter is set on the virtual server in advance; and a second sending component 40, which is connected with the first sending component 30 and is configured to send the converted code stream to a terminal for video playing.

The method for processing the video based on the virtual desktop provided in Embodiment 2 is further described below in conjunction with FIG. 7.

FIG. 7 shows a flow diagram of processing a converted original code stream in a terminal according to an example Embodiment 2 of the disclosure; in FIG. 7, after acquiring the original code stream of the video file to be played right now, the virtual desktop system sends the original code stream to a video format converter that is preset on a virtual server in advance, so that the video format converter converts the format of the video file consisting of the original code stream; after conversion, the virtual desktop system transmits the converted code stream to a terminal, which then plays the video file via a media player software after decoding.

It is needed to note that this video processing method is an example embodiment of the video playing method provided in Embodiment 1; here, the video format converter added on the virtual server is a common component (at present, many manufacturers have off-the-shelf product; all products that have a video format conversion function and can be integrated on a virtual server can be used); of course, the key of this video processing method is not the video converter. In this video processing method, the terminal needs a decoder which supports the converted format.

The advantage of this video processing method lies in saving the bandwidth resource for a client which supports a decoding function.

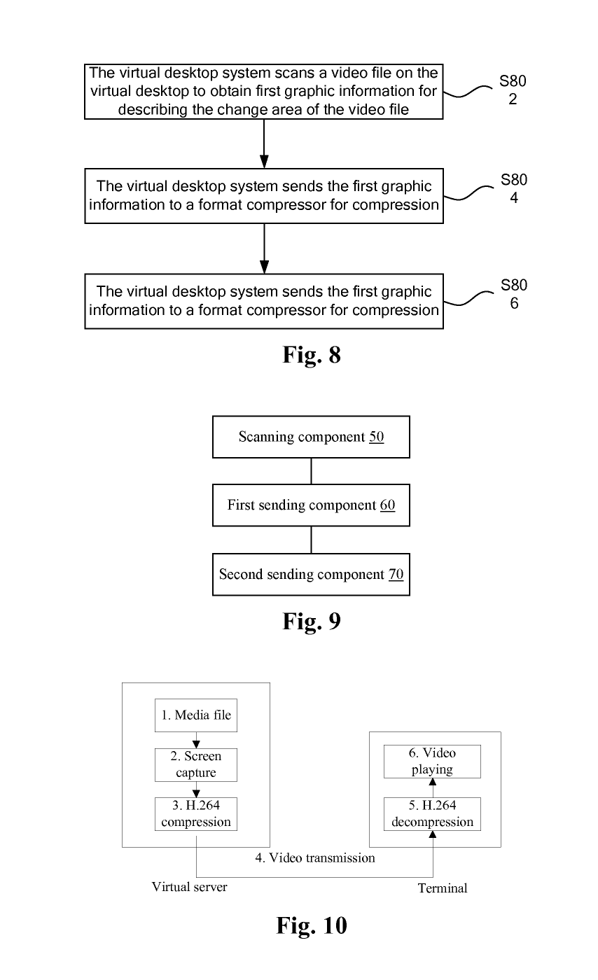

FIG. 8 shows a flowchart of a method for processing a video based on a virtual desktop according to Embodiment 3 of the disclosure; as shown in FIG. 8, the method mainly includes following steps (S802 to S806):

S802: The virtual desktop system scans a video file on the virtual desktop to obtain first graphic information for describing the change area of the video file.

S804: The virtual desktop system sends the first graphic information to a format compressor for compression.

S806: The virtual desktop system sends second graphic information obtained by compression to a terminal for video playing.

In this embodiment, the first graphic information includes: information located in a GPU.

FIG. 9 shows a structure diagram of a device for processing a video based on a virtual desktop according to Embodiment 3 of the disclosure; this device is configured to implement the method for processing a video based on a virtual desktop shown in FIG. 8; as shown in FIG. 9, the device for processing a video based on a virtual desktop includes: a scanning component 50, which is configured to scan a video file on the virtual desktop to obtain first graphic information for describing the change area of the video file; a first sending component 60, which is connected to the scanning component 50 and is configured to send the first graphic information to a format compressor for compression; and a second sending component 70, which is connected to the first sending component 60 and is configured to send second graphic information obtained by compression to a terminal for video playing.

In this embodiment, the first graphic information includes: information located in a GPU.

The method for processing a video based on a virtual desktop provided in Embodiment 3 of the disclosure is described below in further detail in conjunction with FIG. 10.

FIG. 10 shows a flow diagram of the implementation of an image compression sharing method according to an example Embodiment 3 of the disclosure; in FIG. 10, when a user starts a media player program (media player) on a virtual desktop to open a media file (video file), the virtual desktop system first scans the desktop, scans out the changed area of the video file and obtains corresponding graphic information (mainly referring to the information in the GPU) of the changed area. Then the virtual desktop system sends the graphic information to a video format compressor for compression (at present, the better compression ratio is H.264 format); after finishing the compression, the video format compressor returns the code stream to a virtual server of the virtual desktop. The virtual desktop system transmits the compressed graphic information to a terminal through a network. After receiving the compressed graphic information, the terminal first decompresses the graphic information and then recycles the graphic information.

It is needed to note that this processing method is properly modified based on the video playing method provided in Embodiment one, specifically, a video format compressor is added to share the video compression operation, so as to reduce the occupation of CPU resources. The video format compressor adopted in this processing method is a mature product, which is not the key of the processing method; the video format compressor mainly is to finish the compression of code stream, and what format for compression to is not limited in actual application.

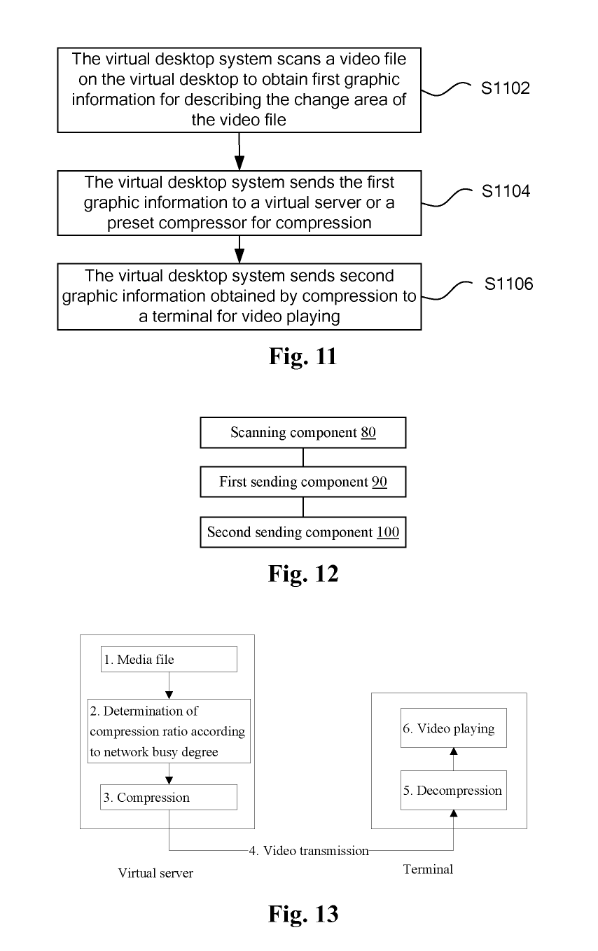

FIG. 11 shows a flowchart of a method for processing a video based on a virtual desktop according to Embodiment 4 of the disclosure; as shown in FIG. 11, the method mainly includes following steps (S1102 to S1106):

S1102: The virtual desktop system scans a video file on the virtual desktop to obtain first graphic information for describing the change area of the video file.

S1104: The virtual desktop system sends the first graphic information and a preset compression policy to a virtual server or a preset compressor for compression, wherein the preset compression policy is used for dynamically adjusting different compression ratios based on different network bandwidths.

S1106: The virtual desktop system sends second graphic information obtained by compression to a terminal for video playing.

In this embodiment, the preset compression policy includes multiple different compression ratios, and the compression ratio is in proportion to the network bandwidth.

In this embodiment, the first graphic information includes: information located in a GPU.

FIG. 12 shows a structure diagram of a device for processing a video based on a virtual desktop according to Embodiment 4 of the disclosure; this device is configured to implement the method for processing a video based on a virtual desktop shown in FIG. 11; as shown in FIG. 12, the device for processing a video based on a virtual desktop includes: a scanning component 80, which is configured to scan a video file on the virtual desktop to obtain first graphic information for describing the change area of the video file; a first sending component 90, which is connected to the scanning component 80 and is configured to send the first graphic information and a preset compression policy to a virtual server or a preset compressor for compression, wherein the preset compression policy is used for dynamically adjusting to different compression ratios based on different network bandwidths; a second sending component 100, which is connected to the first sending component 90 and is configured to send second graphic information obtained by compression to a terminal for video playing.

The method for processing a video based on a virtual desktop provided in Embodiment 4 of the disclosure is described below in further detail in conjunction with FIG. 13.

FIG. 13 shows a flow diagram of the implementation of a method for dynamically adjusting a compression ratio based on a network bandwidth according to an example embodiment 4 of the disclosure. In FIG. 13, when a user starts a media player program (media player) on a virtual desktop to open a media file (video file), the virtual desktop system first scans the desktop, scans out the changed area of a video file and obtains corresponding graphic information (mainly referring to the information in the GPU) of the changed area. The virtual desktop system adopts different compression policies (each compression policy includes a different compression ratio, for example: if in the condition of 100 Kbps of network bandwidth, the compression ratio is 1080P; if in the condition of 10 Kbps of network bandwidth, the compression ratio is 480P) according to the actual network condition (network bandwidth); it is needed to note that different compression policies can be configured in advance in the virtual desktop system. The virtual desktop system transmits the compressed graphic information to a terminal through a network. After receiving the compressed graphic information, the terminal first decompresses the graphic information and then recycles the graphic information.

It is needed to note that the compression of the video file in this processing method can be finished in the virtual server, or in the added video format compressor. The key of this processing method lies in the dynamic selection of compression ratio according to an actual network bandwidth (multiple different compression ratios are configured in advance). Through this processing method, users can view video files smoothly in real time. The biggest advantage of this processing method is that: in the condition that network bandwidth resources are abundant, users can view clearer videos; in the condition that network bandwidth resources are deficient, users will view slightly blurry videos; however, these video files can be smoothly played, and no playing failure occurs in the video playback.

In view of the above four embodiments, it is needed to emphasize that the four embodiments all can guarantee the smooth playback of videos; modification process thereof is very simple and practical, and a high practicability is enabled.

From the above description, it can be seen that the disclosure achieves following technical effects: the disclosure solves the problem that the playing of high-definition videos on a virtual desktop server is prone to failure because of the poor performance of the virtual server or that the bandwidth between the terminal and the virtual server is insufficient in related art, avoids or reduces the occupation of CPU resources of the host of the virtual machine and achieves smooth playing of the video files, by any one of the following methods that: the original code stream of the video file is directly sent to the terminal to play; a video converter preset on the virtual server converts the video file and then sends the converted video file to the terminal to decode and play, a video format compressor compresses the graphic information of the changed area of the video file and then sends the compressed file to the terminal to decompress and play, or the virtual desktop system compresses the graphic information of the changed area of the video file by using the compression ratio dynamically selected according to the current network bandwidth and then sends the compressed file to the terminal to decompress and play.

Obviously, those skilled in the art should understand that the components or steps described above can be implemented by a common computer device; the components or steps can be integrated on a single computing device or distributed on a network composed of a plurality of computing devices; optionally, the components or steps can be implemented by a programming code executable by a computing device, thus they can be stored in a storage device to be executed by a computing device and executed in a different order in some cases, or manufactured into individual integrated circuit component respectively, or several of them can be manufactured into a single integrated circuit component to implement; in this way, the disclosure is not limited to any combination of specific hardware and software.

The above are only the preferred embodiments of the disclosure and not intended to limit the disclosure. For those skilled in the art, various modifications and changes can be made to the disclosure. Any modification, equivalent substitute and improvement made within the spirit and principle of the disclosure shall fall into the scope of protection of the disclosure.

1. A method for playing a video based on a virtual desktop, comprising:
receiving, by a terminal, an original code stream of a video file to be played currently, wherein the original code stream is sent to the terminal by a virtual desktop system after the virtual desktop acquires the original code stream; and
playing, by the terminal, the video file according to the original code stream.

2. A device for playing a video based on a virtual desktop, comprising:
a receiving component, configured to receive an original code stream of a video file to be played currently, wherein the original code stream is sent to a terminal by a virtual desktop system after the virtual desktop acquires the original code stream; and
a playing component, configured to play the video file according to the original code stream.

3. A method for processing a video based on a virtual desktop, comprising:
sending, by a virtual desktop system, an original code stream of a video file to be played currently to a video format converter for format conversion;
sending, by the virtual desktop system, the converted code stream to a terminal for video playing.

4. The method according to claim 3, wherein before the virtual desktop system sends the original code stream of the video file to be played currently to the video format converter for format conversion, the method further comprises:
acquiring, by the virtual desktop system, the original code stream from the video file.

5. The method according to claim 3, wherein the video format converter is set on a virtual server in advance.

6. A device for processing a video based on a virtual desktop, comprising:
a first sending component, configured to send an original code stream of a video file to be played currently to a video format converter for format conversion, wherein the video format converter is set on a virtual server in advance; and
a second sending component, configured to send the converted code stream to a terminal for video playing.

7. A method for processing a video based on a virtual desktop, comprising:
scanning, by a virtual desktop system, a video file on the virtual desktop to obtain first graphic information for describing a change area of the video file;
sending, by the virtual desktop system, the first graphic information to a format compressor for compression; and
sending, by the virtual desktop system, second graphic information obtained by compression to a terminal for video playing.

8. The method according to claim 7, wherein the first graphic information comprises: information located in a Graphics Processing Unit (GPU).

9. A device for processing a video based on a virtual desktop, comprising:
a scanning component, configured to scan a video file on the virtual desktop to obtain first graphic information for describing a change area of the video file;
a first sending component, configured to send the first graphic information to a format compressor for compression; and
a second sending component, configured to send second graphic information obtained by compression to a terminal for video playing.

10. The device according to claim 9, wherein the first graphic information comprises: information located in a Graphics Processing Unit (GPU).

11. A method for processing a video based on a virtual desktop, comprising:
scanning, by a virtual desktop system, a video file on the virtual desktop to obtain first graphic information for describing a change area of the video file;
sending, by the virtual desktop system, the first graphic information and a preset compression policy to a virtual server or a preset compressor for compression, wherein the preset compression policy is used for dynamically adjusting to different compression ratios based on different network bandwidths; and
sending, by the virtual desktop system, second graphic information obtained by compression to a terminal for video playing.

12. The method according to claim 11, wherein the preset compression policy comprises multiple different compression ratios, wherein a compression ratio is in proportion to a network bandwidth.

13. The method according to claim 11, wherein the first graphic information comprises: information located in a Graphics Processing Unit (GPU).

14. A device for processing a video based on a virtual desktop, comprising:
a scanning component, configured to scan a video file on the virtual desktop to obtain first graphic information for describing a change area of the video file;
a first sending component, configured to send the first graphic information and a preset compression policy to a virtual server or a preset compressor for compression, wherein the preset compression policy is used for dynamically adjusting to different compression ratios based on different network bandwidths; and
a second sending component, configured to send second graphic information obtained by compression to a terminal for video playing.

15. The method according to claim 4, wherein the video format converter is set on a virtual server in advance.

16. The method according to claim 12, wherein the first graphic information comprises: information located in a Graphics Processing Unit (GPU).
